(19) United States
(12) Patent Application Publication
(10) Pub. No.: US 2016/0329183 A1
(43) Pub. Date: Nov. 10, 2016

(54) MOTION SENSING POWER SWITCH

(71) Applicant: Texas Instruments Incorporated, Dallas, TX (US)

(72) Inventors: Leonardo Estevez, Rowlett, TX (US); Terry Lee Sculley, Lewisville, TX (US); Wei-Yan Shih, Plano, TX (US); Wen Li, McKinney, TX (US); David Brian Barkin, San Francisco, CA (US)

(21) Appl. No.: 14/706,776

(22) Filed: May 7, 2015

(51) Int. Cl. H01H 59/00

(52) U.S. Cl. CPC H01H 59/0009

(57) ABSTRACT

The present disclosure provides a power switch for use in a power management system including a power source for supplying an electrical current, and a load for receiving the electric current upon establishing a circuit with the power source. The power switch includes a motion sensor, a timer, and a gate. The motion sensor is configured to sense a motion related to an operation of the load and generate an idle signal when the sensed motion is below a predetermined threshold. The timer is coupled with the motion sensor, and it is configured to activate a power-off signal upon detecting the idle signal for a predetermined time period. The gate is coupled with the timer, and it is configured to either complete the circuit when the power-off signal is inactive or break up the circuit when the power-off signal is active.

### BACKGROUND

Consumer electronic devices typically include various power management systems that help reduce the power consumption of these devices when they are left idle. However, these conventional power management systems consume a sizable amount of power in the process of reducing the power consumption of the main electrical loads. From a power conservation standpoint, these conventional power management systems are not too efficient. Moreover, these conventional power management systems are often integrated to the consumer electronic devices, such that they are not adaptable to different power reception platforms. As a result, these conventional power management systems can be too costly to implement for devices having low profit margins.

### SUMMARY

The present disclosure describes power management systems that provide low cost, highly adaptable, and energy efficient power management solutions to electronic devices.

In one implementation, for example, the present disclosure provides a power management system that includes a power receptacle, a load, and a switch. The power receptacle has a positive terminal and a negative terminal that are configured to receive a power source for supplying an electric current. The load is coupled with the positive and negative terminals of the power receptacle, and the load is configured to receive the electric current upon establishing a circuit with the power source. The switch is structured for being deposed between the power source and the load, and the switch includes a motion sensor, a timer, and a gate. The motion sensor is configured to sense a motion of the load and generate an idle signal when the sensed motion is below a predetermined threshold. The timer is coupled with the motion sensor, and it is configured to generate a power-off signal upon detecting the idle signal for a predetermined time period. The gate is coupled with the timer, and it is configured to break up the circuit by isolating the load from the power source upon receiving the power-off signal.

In another implementation, for example, the present disclosure provides a power management system that includes a power receptacle, a load, a user interface, and a switch. The power receptacle is configured to receive a power source. The load is coupled with the power receptacle, and it is configured to receive an electric current upon establishing a circuit with the power source. The user interface is coupled with the load, and it is configured to receive a user input for operating the load while the load conducts the electric current. The switch is structured for being deposed between the power source and the load, and the switch includes a motion sensor, a timer, a gate. The motion sensor is configured to sense a motion induced by the user input and generate an idle signal when the sensed motion is below a predetermined threshold. The timer is coupled with the motion sensor, and it is configured to generate a power-off signal upon detecting the idle signal for a predetermined time period. The gate is coupled with the timer, and it is configured to break up the circuit by isolating the load from the power source upon receiving the power-off signal.

In yet another implementation, for example, the present disclosure provides a micro-electromechanical system based (MEMS-based) switch for use in a power management system, which includes a power source for supplying an electrical current, and a load that is configured to receive the electric current upon establishing a circuit with the power source. The MEMS-based switch includes a MEMS-based motion sensor, a timer, and a gate. The MEMS-based motion sensor is configured to sense a motion related to an operation of the load and generate an idle signal when the sensed motion is below a predetermined threshold. The timer is coupled with the MEMS-based motion sensor, and it is configured to activate a power-off signal upon detecting the idle signal for a predetermined time period. The gate is structured for being deposed between the load and the power source. Moreover, the gate is coupled with the timer, and it is configured to either complete the circuit when the power-off signal is inactive or break up the circuit when the power-off signal is active.

The described systems and techniques can be implemented in electronic circuitry, computer hardware, firmware, software, or in combinations of them, such as the structural means disclosed in this specification and structural equivalents thereof. This can include at least one computer-readable medium embodying a program operable to cause one or more data processing apparatus (e.g., a signal processing device including a programmable processor) to perform operations described. Thus, program implementations can be realized from a disclosed method, system, or apparatus; and apparatus implementations can be realized from a disclosed system, computer-readable medium, or method. Similarly, method implementations can be realized from a disclosed system, computer-readable medium, or apparatus; and system implementations can be realized from a disclosed method, computer-readable medium, or apparatus.

For example, one or more disclosed embodiments can be implemented in various systems and apparatus, including, but not limited to, an electronic entertainment apparatus (e.g., a battery-powered toy), a special purpose data processing apparatus (e.g., a wireless communication device such as a wireless access point, a remote environment monitor, a router, a switch, a computer system component, a medium access unit), a mobile data processing apparatus (e.g., a wireless client, a cellular telephone, a smart phone, a personal digital assistant (PDA), a mobile computer, a digital camera), a general purpose data processing apparatus such as a computer, or combinations of these.

### DRAWING DESCRIPTIONS

FIG. 1 shows a perspective view of an exemplary electronic device and a schematic view of an exemplary power management system implemented therein according to an aspect of the present disclosure.

FIG. 2 shows a schematic view of an exemplary power management system according to an aspect of the present disclosure.

FIG. 3 shows a schematic view of an exemplary power switch according to an aspect of the present disclosure.

FIG. 4 shows a partial cross-sectional view of an exemplary power management system according to an aspect of the present disclosure.

FIG. 5 shows a partial cross-sectional view of an exemplary power management system according to another aspect of the present disclosure.

Like reference symbols in the various drawings indicate like elements. Details of one or more implementations of the present disclosure are set forth in the accompanying drawings and the description below. The figures are not drawn to scale and they are provided merely to illustrate the disclosure. Specific details, relationships, and methods are set forth to provide an understanding of the disclosure. Other features and advantages may be apparent from the description and drawings, and from the claims.

### DETAILED DESCRIPTION

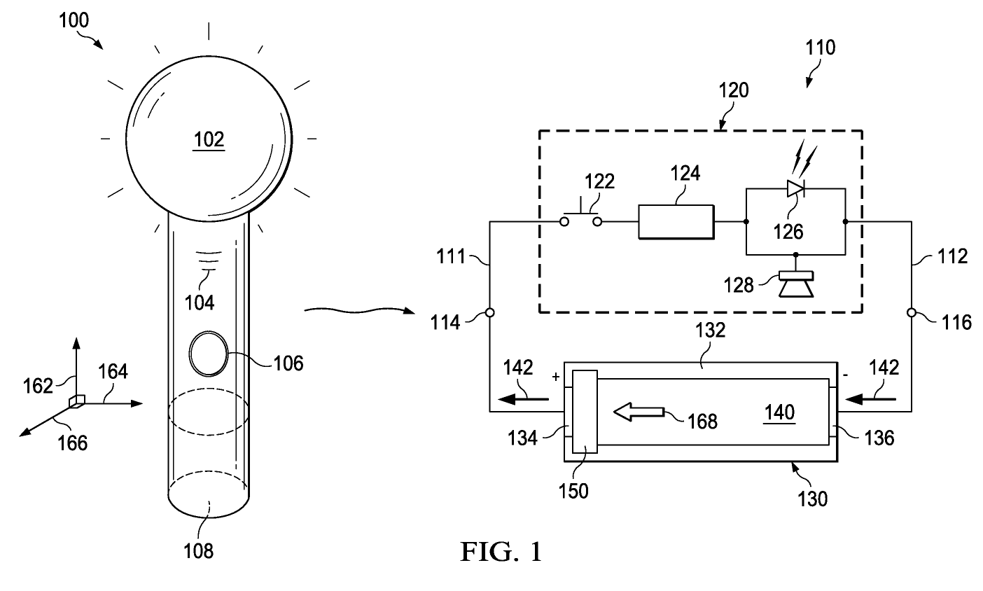

FIG. 1 shows a perspective view of an exemplary electronic device 100 and a schematic view of an exemplary power management system 110 implemented therein according to an aspect of the present disclosure. The electronic device 100 can be a battery-powered device having various electric load components. For instance, the electronic device 100 can be a toy microphone having an illumination component 102, an audio component 104, and a user input component 106. The electronic device 100 also includes a power receptacle 108 for receiving a power source that provides electric energy for operating the electric load components.

A user (e.g., a human user) can submit a user input by using the user input component 106. For example, the user input component 106 can be a capacitive button that can be depressed to complete an electric circuit. Upon receiving the user input, the electronic device 100 will generate one or more simulated outputs. For example, the illumination component 102 can be powered to emit light, whereas the audio component can be powered to play an audio recording. The power receptacle 108 has a structure to receive a power source (e.g., removable battery), which is used for powering the illumination component 102 and the audio component 104.

The electronic device 100 is generally in motion when it is being operated by a human user. Such a motion can be expressed by three orthogonally arranged motion vectors 162, 164, and 166. The electronic device 100 includes a power management system, such as the power management system 110, that will cut off the power supply to the electric load (e.g., the illumination component 102, the audio component 104, and/or the user input component 106) when such a motion is not detected for a predetermined amount of time. As a result, the electronic device 100 is able to conserve energy when it is not being used or in operation.

The power management system 110 includes an electric load system 120, a power receptacle 130, a power source 140, and a power switch 150. The power receptacle 130 provides a housing that defines a power receptacle chamber 132, in which the power source 140 (e.g., a battery) can be housed. Attached to the housing, the power receptacle includes a positive terminal 134 and a negative terminal 136. The positive terminal 134 and the negative terminal 136 are configured to receive the power source 140 for supplying an electric current 142.

The power source 140 can be coupled with the electric load system 120 via the positive and negative terminals 134 and 136 of the power receptacle 130. In particularly, the electric load system 120 is coupled with the positive terminal 134 via a first conductive wire 111, and the electric load system 120 is coupled with the negative terminal 136 via a second conductive wire 112. When electrically coupled with each other, the power source 140 and the electric load system 120 establish an electric circuit, through which the electric load system 120 receives the electric current 142 from the power source 140.

The electric load system 120 may include various electronic components for performing the intended function of the electronic device 100. In the example of a toy microphone, the electric load system 120 includes a capacitive input switch 122, a microcontroller 124, a light emitting diode 126, and a speaker 128. The capacitive input switch 122 is configured to perform the function of the user input component 106. When depressed, the capacitive input switch 122 is activated for conducting the electric current 142 from the positive terminal 134 of the power receptacle 130 to the microcontroller 124.

The microcontroller 124 is coupled with the capacitive input switch 122, and it is programmed to process the user inputs and generate the corresponding outputs. In the case of a binary user input as received by the capacitive input switch 122, the microcontroller 124 is configured by programmable instructions to direct the electric current 142 to energize the light emitting diode 126 and/or the speaker 128. The light emitting diode 126 is configured to perform the function of the illumination component 102. When energized, the light emitting diode 126 generates a visual display by consuming the electric energy carried by the electric current 142. The speaker 128 is configured to perform the function of the audio component 104. When energized, the speaker 128 generates an audible wave by consuming the electric energy carried by the electric current 142.

The power switch 150 is structured for being placed between the power source 140 on the one hand and any component of the electric load system 120 on the other hand. In one implementation, for example, the power switch 150 is insertable between the power source 140 and the positive terminal 134 of the power receptacle 130. Alternatively, the power switch 150 is insertable between the power source 140 and the negative terminal 136 of the power receptacle 130. Depending on the particular implementation, the power switch 150 may include a mechanical adaptor, such that the power switch 150 is attachable to any one of the positive terminal 134, the negative terminal 136, and the power source 140.

The power switch 150 is configured to sense a motion of a mechanical load belonging to the electronic device 100. Depending on the mechanical design of the electronic device 100, the mechanical load may include any physical structure thereof that has the same, or substantially the same, motion when the electronic device 100 is being displaced or moved by a mechanical force. In one implementation, for example, the power source 140, which is housed within the power receptacle chamber 132, is a part of the mechanical load when the power source 140 and the power receptacle chamber 132 are firmly or rigidly attached to the body of the electronic device 100. More particularly, the power switch 150 is configured to sense a physical stress 168 between the power receptacle chamber 132 and the power source 140.

In another implementation, for example, the electric load system 120 can be a part of the mechanical load when the mechanical force asserted thereto is transferrable to a position at which the power switch 150 is disposed. That is, when a mechanical force is asserted to the electric load system 120, the body of the electronic device 100 helps transfer such force to the power source 140, thereby creating a physical stress 168 between the power receptacle chamber 132 and the power source 140. By being positioned between the power receptacle chamber 132 and the power source 140, the power switch 150 is able to approximate the motion of the electric load system 120 by sensing the physical stress 168.

Based upon the sensed motion, the power switch 150 is configured to generate an idle signal when the sensed motion is below a predetermined threshold. This predetermined threshold is used for deciding whether or not the electronic device 100 is in operation or in active use by a user. Thus, the value of the predetermined threshold is associated with the motion sensitivity of the electronic device 100. In the category of electronic toys, which generally have low motion sensitivities, the predetermined threshold can be set relatively high. As a result, slight movements or the absence of movement of the electronic device 100 will trigger the generation of the idle signal. In the category of motion sensitive apparatus (e.g., a wireless mouse), the predetermined threshold can be set relatively low, such that slight movements of the electronic device 100 may prevent the idle signal from being generated.

The power switch 150 is configured to generate a power-off signal when idle signal has been generated continuously for a predetermined time period. This power-off signal represents the scenario in which the electronic device 100 are not in operation or in active use for a prolong period of time. For instance, if the electronic device 100 is a toy gun that has been idled for more than 30 minutes, it is assumed that the toy gun is no longer in active use. In that case, the power switch 150 can initiate the power-off process by generating the power-off signal. During the power-off process, the power switch 150 is configured to break up the electric circuit by isolating the electric load system 120 from the power source 140. As a result, the electric load system 120 will not receive any electric current 142 during the power-off process. Once the power switch 150 senses that the electronic device 100 is in motion exceeding the predetermined threshold, the power switch 150 will stop generating the power-off signal. When that happens, the electric circuit is re-established between the electric load system 120 and the power source 140.

The power switch 150 acts as a motion-based circuit breaker. When the power switch 150 is insertable between the power source 140 and the positive terminal 134 of the power receptacle 130, the power switch 150 is configured to break up the electric circuit by insulating the positive terminal 134 from the power source 140 upon receiving the power-off signal. When the power switch 150 is insertable between the power source 140 and the negative terminal 136 of the power receptacle 130, the power switch 150 is configured to break up the electric circuit by insulating the negative terminal 136 from the power source 140 upon receiving the power-off signal.

Depending on the particular implementation, the power management system 110 may include additional receptacles for receiving the power switch 150. For instance, the power management system 110 may include a switch receptacle at a first node 114 positioned along the first conductive wire 111. In this particular implementation, the power switch 150 is configured to break up the electric circuit by intercepting the electric current 142 at the first node 114. Alternatively, the power management system 110 may include another receptacle at a second node 116 positioned along the second conductive wire 112. In this particular implementation, the power switch 150 is configured to break up the electric circuit by intercepting the electric current 142 at the second node 116.

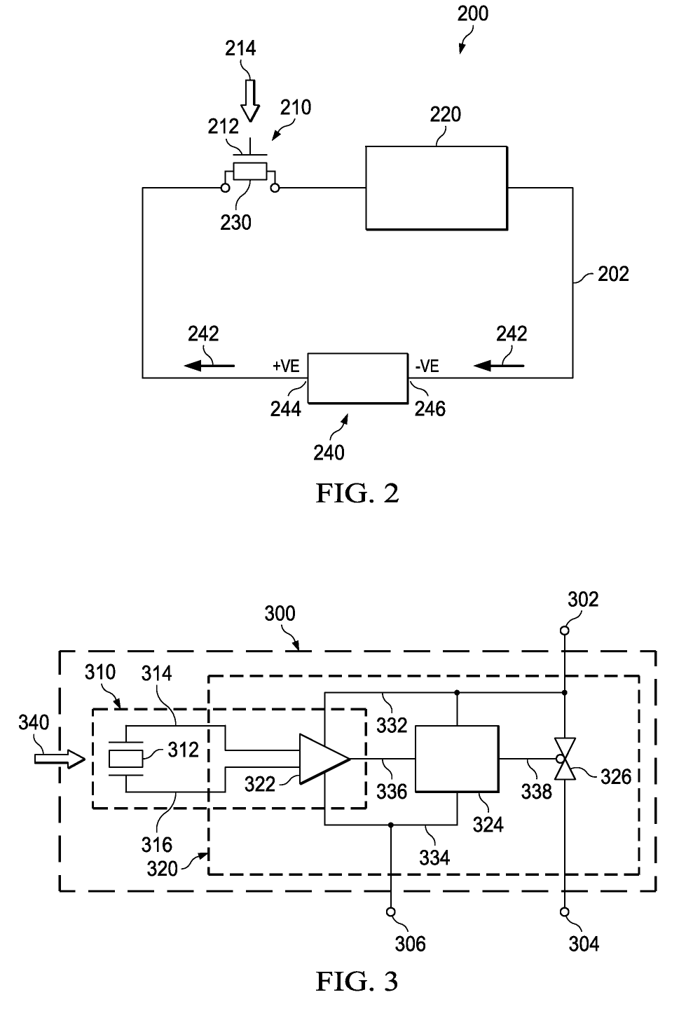

FIG. 2 shows a schematic view of an exemplary power management system 200 according to an aspect of the present disclosure. Like the power management system 100, the power management system 200 includes a power receptacle 240, an electric load 220, and a power switch 230. In addition, the power management system 200 includes a user interface 210 that is coupled with the power switch 230, such that the power switch 230 is enabled to regulate the power consumption of the power management system 200 based on the operation of the user interface 210.

The power receptacle 240 is configured to receive a power source (e.g., the power source 140) between its positive terminal 244 and negative terminal 246. The electric load 220 is coupled with the power receptacle 240, such that the electric load 220 is configured to receive an electric current 242 upon establishing an electric circuit 202 with the power source. The user interface 210 is an electronic component that is enabled for receiving an input from a user. For instance, the user interface 210 can be a keyboard of a toy piano. The user interface 210 is coupled with the electric load 220. The input received by the user interface 210 is used for operating the electric load 220 while the electric load 220 conducts the electric current 242.

The power switch 230 is structured for being placed between the power source in the power receptacle 240 and the electric load 220. In one implementation, the power switch 230 can be integrated to the user interface 210. In another implementation, the power switch 230 can be attachable to the user interface 210. Either way, the power switch 230 is positioned adjacent to a user input receptacle 212 (e.g., a capacitive switch) of the user interface 210. As such, the power switch 230 is configured to sense a motion induced by the user input received by the input receptacle 212. In one implementation, for example, the power switch 230 is configured to sense a physical stress 214 asserted by a user against the input receptacle 212. The power switch 230 then correlates the sensed physical stress 214 to the motion (which is induced by the user input) of the input receptacle 212. Upon sensing the motion, the power switch 230 is configured to generate an idle signal when the sensed motion is below a predetermined threshold. Since the input receptacle 212 is likely to have higher motion sensitivity than other devices, the predetermined threshold can be set at a relatively low value.

The power switch 230 is configured to generate a power-off signal when the idle signal has been generated continuously for a predetermined time period. This power-off signal represent the scenario in which the user interface 210 and the electric load 220 are not in operation or not in active use for a prolong period of time. In that case, the power switch 230 can initiate the power-off process by generating the power-off signal. During the power-off process, the power switch 230 is configured to break up the electric circuit 202 by isolating the electric load 220 from the power source housed in the power receptacle 240. As a result, the electric load 220 will not receive any electric current 242 during the power-off process. Once the power switch 230 senses that the user interface 210 receives a new set of user inputs, the power switch 230 will stop generating the power-off signal. And when that happens, the electric circuit 202 is re-established between the electric load 220 and the power source in the power receptacle 240.

The power switch 230, along with the user interface 210, can be positioned on either side of the electric load 220. In one implementation, for example, the power switch 230 is positioned between the electric load 220 and the positive terminal 244 of the power receptacle 240. Upon receiving the power-off signal, the power switch 230 is configured to break up the electric circuit 202 by disconnecting the electric load 220 from the positive terminal 244. In another implementation, for example, the power switch 230 is positioned between the electric load 220 and the negative terminal 246 of the power receptacle 240. Upon receiving the power-off signal, the power switch 230 is configured to break up the electric circuit 202 by disconnecting the electric load 220 from the negative terminal 246.

FIG. 3 shows a schematic view of an exemplary power switch 300 according to an aspect of the present disclosure. The power switch 300 can be used for implementing the power switch 150 as described in FIG. 1 as well as the power switch 230 as described in FIG. 2. The power switch 300 includes a motion sensing circuit 310 and a switch logic circuit 320. The motion sensing circuit 310 includes a sensor that is configured to sense the motion of a mechanical load of an electronic device (e.g., the electronic device 100) to which the power switch 300 is applied. Specifically, the motion sensor has electromechanical properties that enable the motion sensor to convert a sensed motion, or a physical stress 340 induced by such a motion, to a pair of differential outputs, such as a first differential output 314 and a second differential output 316. The voltage difference of the first and second differential outputs 314 and 316 tracks the magnitude of the relative motion.

In one implementation, for example, the motion sensor is implemented by an accelerometer. In another implementation, for example, the motion sensor is implemented by a piezoelectric sensor 312. The piezoelectric sensor 312 can be an external component to the switch logic circuit 320. For instance, the piezoelectric sensor 312 can be a piezoelectric disc wired and bonded to an integrated circuit that implements the switch logic circuit 320. Alternatively, the piezoelectric sensor 312 can be an integral part of the switch logic circuit 320. For instance, the piezoelectric sensor 312 can be a micro-electromechanical system based (MEMS-based) device incorporable to the switch logic circuit 320. When the power switch 300 incorporates MEMS-based devices, such as a MEMS-based motion sensor (e.g., an accelerometer or a piezoelectric sensor), the power switch 300 becomes a MEMS-based power switch.

The motion sensing circuit 310 also includes an amplifier stage 322, which is configured to receive the first differential output 314 and the second differential output 316 generated by the motion sensor, such as the piezoelectric sensor 312. To lower manufacturing cost, the amplifier stage 322 can be fabricated along with the other components of the switch logic circuit 320 into a single integrated circuit.

The switch logic circuit 320 includes a first power port 302, a second power port 304, and an auxiliary power port 306. These three power ports 302, 304, and 306 are accessible via bonding pads on the integrated circuit inside which the switch logic circuit 320 is implemented. The first power port 302 is used for receiving an external drain supply. For instance, the first power port 302 can be coupled with the positive terminal of the power source 140 as shown in FIG. 1. The second power port 304 is used for receiving an external source supply. For instance, the second power port 304 can be coupled with the negative terminal 136 of the power receptacle 134.

When the power switch 300 is at its ON state, the first power port 302 and the second power port 304 are coupled with each other to allow an electric current (e.g., the electric current 142) to flow through, provided that an electric circuit has been established outside of the power switch 300. When the power switch 300 is at its OFF state, the first power port 302 is decoupled from the second power port 304 such that the electric current (e.g., the electric current 142) is intercepted by the power switch 300.

The auxiliary power port 306 is used for receiving power for use internal to the switch logic circuit 320. Depending on the internal power configuration, the auxiliary power port 306 can be coupled with either an external drain supply or an external source supply. For example, in a configuration that the internal drain node 332 is coupled to the first power port 302 for accessing an external drain supply, the auxiliary power port 306 is coupled with an external source supply separately from the second power port 304. That way, the internal source node 334 can access the external source supply via the auxiliary power port 306. In an alternative configuration, which is modified from the configuration as shown in FIG. 3, the internal source node 334 may be coupled with the second power source 304 for accessing an external source supply. That way, the internal drain node 332 may no longer be coupled with the first power port 302. Instead, the internal drain node 332 is coupled with the auxiliary power port 306 for accessing an external drain supply separately from the first power port 302.

The switch logic circuit 320 also includes an idle timer 324 and a power gate 326. Together the internal drain node 332 and the internal source node 334 provide a power grid for enabling the amplifier stage 322 and the idle timer 324. While enabled, the amplifier stage 322 is configured to generate an idle signal 336 when the sensed motion is below a predetermined threshold. Depending on the placement of the motion sensor (e.g., the piezoelectric sensor 312), the sensed motion can be approximated based on a physical stress 340 asserted against the motion sensor. Referring to FIG. 1, for example, the physical stress 168 can be created between the power receptacle chamber 132 and the power source 140, and it can be detected by the motion sensor of the power switch 150. And referring to FIG. 2 for another illustration, the physical stress 214 is induced by a user input applied to the input receptacle 212, and it can be detected by the motion sensor of the power switch 230. In either case, the physical stress is extrapolated for approximating the relevant motion of an electronic device to which the power switch (e.g., the power switch 150, 230, or 300) is applied.

To allowed proper motion sensing, or physical stress sensing, the motion sensor (e.g., the piezoelectric sensor 312) is placed at certain positions within an electric circuit. In one implementation, for example, the motion sensor can be inserted between a power receptacle chamber (e.g., the power receptacle chamber 132) and a power source (e.g., the power source 140) for sensing the motion of a mechanical load of the electric device. In another implementation, for example, the motion sensor can be attached to the user interface (e.g., the user interface 210) for sensing the motion induced by the user input.

The motion sensor (e.g., the piezoelectric sensor 312) is coupled with the amplifier stage 322 to deliver the first and second differential outputs 314 and 316. The amplifier stage 322 either receives or internally develops a reference voltage for comparing with the voltage difference between the first and second differential outputs 314 and 316. The reference voltage corresponds to the predetermined threshold of sensed motion as previously described. As such, the amplifier stage 322 generates the idle signal 336 when the voltage difference between the first and second differential outputs 314 and 316 is below the reference voltage. And the amplifier stage 322 refrains from generating the idle signal 336 when the voltage difference between the first and second differential outputs 314 and 316 exceeds the reference voltage.

The idle timer 324 is coupled with the motion sensing circuit 310. The idle timer 324 is preconfigured or preprogrammed to measure a fixed time period for determining whether an electronic device is no longer in active use or no longer in operation. In one implementation, the idle timer 324 can be a counter preprogrammed to count a predetermined number of clock cycles. In another implementation, the idle timer 324 may include a resistive-capacitive (RC) network preconfigured to a certain charging or discharging period. Depending on the particular circuit design, either the idle timer 324 or the motion senor (e.g., the piezoelectric sensor 312) can incorporate the functional features of the amplifier stage 322. In that case, the idle timer 324 can be coupled directly with the motion sensor. In the event that the idle timer 324 detects that the idle signal 336 has a duration exceeding the predetermined time period (i.e., the fixed time period), the idle timer 324 is configured to generate a power-off signal 338.

The power gate 326 is coupled with idle timer 324, and the power gate 326 is configured to receive the power-off signal 338. The power gate 326 is also coupled between the first power port 302 and the second power port 304. Based upon the power-off signal 338 generated by the idle timer 324, the power gate 326 is configured to regulate the electric current flowing through the first and second power ports 302 and 304. When the power-off signal is inactive, meaning that the electronic device to which the power switch 300 is applied is in active use, the power switch is configured to complete a portion of the electric circuit between the first and second power ports 302 and 304. When the power-off signal is active, meaning that the electronic device to which the power switch 300 is applied is not in active use, the power switch is configured to break up the electric circuit between the first and second power ports 302 and 304. Accordingly, the power gate 326 is structured to either pass or intercept the electric current from the power source to the electric load depending on whether the power-off signal 338 is inactivate or active.

As a specific example, the power gate 326 may adopt a complementary pass gate circuit structure, which is fitted for placement between the electric load and the power source. Moreover, the power gate 326 can be insertable along an electric circuit for intercepting an electric current conducting therethrough.

According to an aspect of the present disclosure, the power switch 300 is sized and fitted for insertion within a power receptacle (e.g., 130 and 240). In one implementation, for example, the power gate 326 is insertable between the positive terminal (e.g., 134 and 244) of the power receptacle (e.g., 130 and 240) and the power source (e.g., 140). As such, the power gate 326 is configured to break up the electric circuit by insulating the positive terminal from the power source upon receiving an active power-off signal 338. In another implementation, for example, the power switch 300 is insertable between the negative terminal (e.g., 136 and 246) of the power receptacle (e.g., 130 and 240) and the power source (e.g., 140). As such, the power gate 326 is configured to break up the electric circuit by insulating the negative terminal from the power source upon receiving an active power-off signal 338.

According to another aspect of the present disclosure, the power switch 300 is sized and fitted for placement outside of a power receptacle (e.g., 130 and 240). In one implementation, for example, the power switch 300 is positioned between the positive terminal (e.g., 134 and 244) of the power receptacle (e.g., 130 and 240) and the electric load (e.g., 120 and 220). As such, the power gate 326 is configured to break up the electric circuit by disconnecting the electric load from the positive terminal upon receiving an active power-off signal 338. In another implementation, for example, the power switch 300 is positioned between the negative terminal (e.g., 136 and 246) of the power receptacle (e.g., 130 and 240) and the electric load (e.g., 120 and 220). As such, the power gate 326 is configured to break up the circuit by disconnecting the electric load from the negative terminal upon receiving an active power-off signal 338.

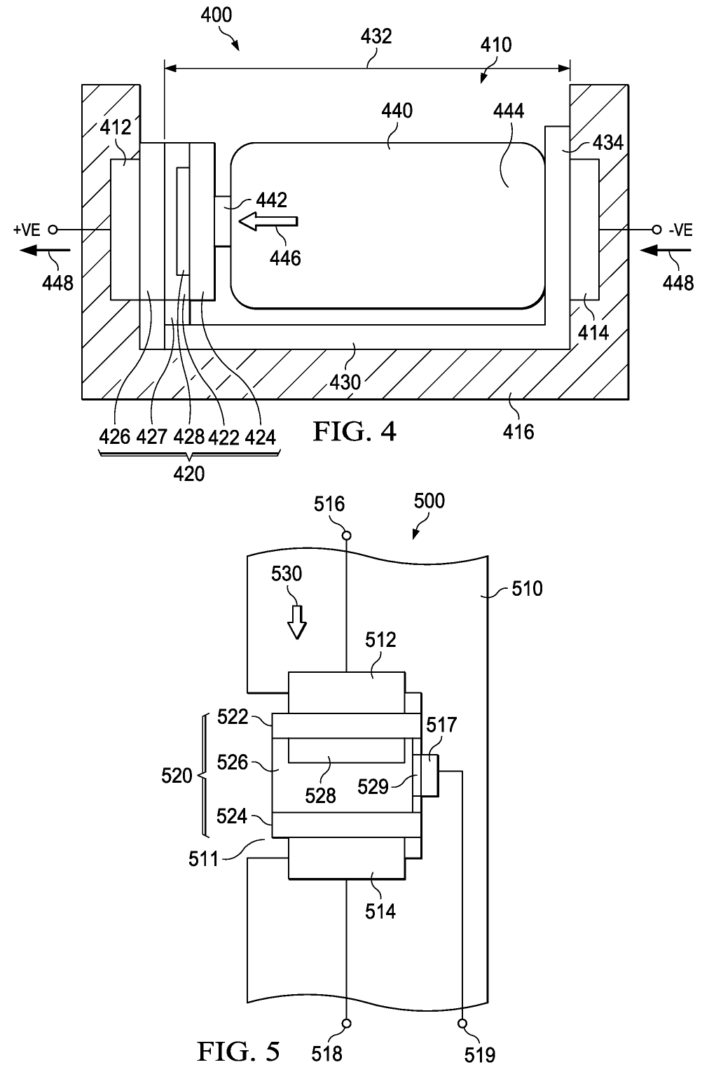

FIG. 4 shows a partial cross-sectional view of an exemplary power management system 400 according to an aspect of the present disclosure. Consistent with the previous description regarding FIGS. 1-3, the power management system 400 includes a power receptacle 410, an insertable power switch 420, an insertable power switch extension 430, and a battery 440. The power receptacle 410 includes a positive terminal 412, a negative terminal 414, and a receptacle chamber 416 embracing the positive and negative terminals 412 and 414. The power receptacle 410 is a part of an electric circuit, which is configured to conduct an electric current 448 when it is established.

The insertable power switch 420 includes an integrated circuit (IC) 422, a first power electrode 424, a second power electrode 426, an auxiliary power electrode 427, and a MEMS-based piezoelectric (MPE) sensor 428. The IC 422 is fabricated with the components in the switch logic circuit 320 as described in FIG. 3, including the amplifier stage 322, the idle timer 324, and the power switch 300. Moreover, the IC 422 includes a socket for receiving the MPE sensor 428. When the IC 422 is integrated with the MPE sensor 428, they can be contained within a single IC package.

The IC 422 also includes bonding pads that are connected with the power ports (e.g., 302, 304, and 306) of the switch logic circuit 320. These bonding pads are coupled with the external electrodes respectively. By means of bonding, for example, the first power electrode 424 is coupled with the first power port 302; the second power electrode 426 is coupled with the second power port 304; and the auxiliary power electrode 427 is coupled with the auxiliary power port 306.

According to an aspect of the present disclosure, the insertable power switch 420 is sized and fitted for insertion within the power receptacle 410. More specifically, the insertable power switch 420 is sized for fitting into a space between the battery 440 and the power receptacle chamber 416. Although FIG. 4 shows that the insertable power switch 420 is inserted between the positive terminal 442 of the battery 440 and the positive terminal 412 of the power receptacle 410, the insertable power switch 420 can also be inserted between the negative terminal 444 of the battery 440 and the negative terminal 414 of the power receptacle 410. The insertable power switch 420 can be removed from the power receptacle 410 as well, and it can be re-adapted to other power receptacles.

When being inserted between the positive terminals 442 and 412 of the battery 440 and the power receptacle 410 respectively, the insertable power switch 420 is configured to complete a primary electric circuit (e.g., 202) for delivering the electric current 448 to the electric load (e.g., 120 and 220). Specifically, the first power electrode 424 is configured to provide electrical coupling between the positive terminal 442 of the battery 440 and the first power port (e.g., 302) of the IC 422, whereas the second power electrode 426 is configured to provide electrical coupling between the positive terminal 412 of the power receptacle 410 and the second power port (e.g., 304) of the IC 422. During its ON state, the insertable power switch 420 is configured to provide electrical coupling between the positive terminal 442 of the battery 440 and the positive terminal 412 of the power receptacle 410.

The MPE sensor 428 is oriented along an axis which the battery 440 aligns with the positive and negative terminals 412 and 414 of the power receptacle 410. With this orientation, the MPE sensor 428 is configured to receive and detect a physical stress 446 between the battery 440 and the body of the power receptacle 410. The physical stress 446 correlates to the motion of the mechanical load. When the physical stress 446 is above the predetermined threshold, it is highly likely that the mechanical load is in motion, thereby indicating that the electronic device, to which the insertable power switch 420 is applied, is in active use or operation. On the other hand, when the physical stress 446 is below the predetermined threshold for an extended time period, it is highly likely that the mechanical load is in rest, thereby indicating that the electronic device, to which the insertable power switch 420 is applied, is not in active use or operation.

Accordingly, when the MPE sensor 428 continuously detects the physical stress 446 above the predetermined threshold, the power gate (e.g., 326) of the insertable power switch 420 allows the electric current 448 to flow from the battery 440 to the power receptacle 410. And when the MPE sensor 428 detects the physical stress 446 correlates to a motion below the predetermined threshold for a predetermined time period, the power gate (e.g., 326) of the insertable power switch 420 breaks up the electrical coupling between the battery 440 and the power receptacle 410. As a result, the insertable power switch 420 intercepts and stops the delivery of the electric current 448 when the electric device is idle for a prolong time period.

The insertable power switch 420 is also configured to complete an auxiliary electric circuit with the insertable power switch extension 430 and the battery 440. The auxiliary electric circuit is independent of the primary electric circuit, such that the auxiliary electric circuit remains established even when the insertable power switch 420 breaks up the primary electric circuit. Specifically, the auxiliary power electrode 427 of the insertable power switch 420 is attachable to the insertable power switch extension 430 to form a bracket for embracing the battery 440. The insertable power switch extension 430 is made of a conductive material such that it can provide electrical coupling between the negative terminal 444 of the battery 440 and the auxiliary power port (e.g. 306) of the insertable power switch 420. More specifically, the insertable power switch extension 430 includes an extension end 434 for coupling with a terminal of the battery 440 with which the insertable power switch 420 is not currently in contact. For example, the extension end 434 is coupled with the negative terminal 444 of the battery 440 as the insertable power switch 420 is not currently in contact with that terminal.

The insertable power switch extension 430 also has an extension length 432 that allows the battery 440 to be snuggly fitted between the insertable power switch 420 and the extension end 434 of the insertable power switch extension 430. The extension length 432 can be adjusted for adapting to power receptacles having various dimensions, rending the insertable power switch 420 highly adaptable to different power receptacle platforms.

FIG. 5 shows a partial cross-sectional view of an exemplary power management system 500 according to another aspect of the present disclosure. Consistent with the previous description regarding FIGS. 1-3, the power management system 500 includes a switch receptacle 510 and an insertable power switch 520. According to an aspect of the present disclosure, the insertable power switch 520 is sized and fitted for placement outside of a power receptacle (e.g., 130, 240, and 410).

Referring to FIG. 1, for instance, the insertable power switch 520 is sized and fitted for placement at the first node 114 and/or the second node 116. When the insertable power switch 520 is inserted into the first node 114, the power gate (e.g., 326) is configured to break up the electric circuit by disconnecting the electric load 120 from the positive terminal 134 upon receiving an active power-off signal (e.g., 338). Alternatively, when the insertable power switch 520 is inserted in the second node 116, the power gate (e.g., 326) is configured to break up the electric circuit by disconnecting the electric load 120 from the negative terminal 136 upon receiving an active power-off signal (e.g., 338).

And referring to FIG. 2, as another example, the insertable power switch 520 is sized and fitted for placement at which the user interface 210 is installed. When the insertable power switch 520 is inserted between the positive terminal 244 and the electric load 220, the power gate (e.g., 326) is configured to break up the electric circuit by disconnecting the electric load 220 from the positive terminal 244 upon receiving an active power-off signal (e.g., 338). Alternatively, when the insertable power switch 520 is inserted between the negative terminal 246 and the electric load 220, the power gate (e.g., 326) is configured to break up the electric circuit by disconnecting the electric load 220 from the negative terminal 246 upon receiving an active power-off signal (e.g., 338).

Consistent with the aforementioned configuration, the switch receptacle 510 can be positioned along the electric circuit (e.g., 202) of a power management system inside of an electronic device. The switch receptacle 510 creates an open circuit along a conductive path of the electric current. The switch receptacle 510 is sized to receive the insertable power switch 520. More specifically, the switch receptacle 510 includes a switch receptacle chamber 511, which defines a space for receiving the insertable power switch 520.

The switch receptacle 510 also includes a first terminal 512, a second terminal 514, and an auxiliary terminal 517, each of which is attached to the inner surface of the switch receptacle 510. For providing electrical contact with the insertable power switch 520, the first, second, and auxiliary terminals 512, 514, and 517 may each protrude from the inner surface of the switch receptacle 510. The first terminal 512 is coupled to a first interception node 516 that is positioned to intercept an electric current (e.g., 142) of an electric circuit. The second terminal 514 is coupled to a second interception node 518 that is positioned to return the intercepted electric current to the electric circuit.

Referring to FIG. 1, for example, the first and second interception nodes 516 and 518 can replace the first node 114 or the second node 116, such that the switch receptacle 510 can intercept the electric current 142. The auxiliary terminal 517 is coupled to an auxiliary node 519 which serves as an internal power supply for the insertable power switch 510 in a manner that is consistent with the description of FIG. 3. Depending on the particular circuit architecture, the auxiliary node 519 may be connected to either the positive terminal (e.g., 134) or the negative terminal (e.g., 136) of the power receptacle (e.g., 130).

The switch receptacle 510 is structured to engage the insertable power switch 520 in such a way that the motion of the electronic device can be detected by the insertable power switch 520 as a physical stress 530. For instance, the first terminal 512 and/or the second terminal 514 may include a spring mechanism through which the motion sensor (e.g., 312) of the insertable power switch 520 can detect the physical stress 530 and approximate the motion of the electronic device.

The insertable power switch 520 includes an integrated circuit (IC) 526, a first power electrode 522, a second power electrode 524, an auxiliary power electrode 529, and a MEMS-based piezoelectric (MPE) sensor 528. The IC 526 is fabricated with the components in the switch logic circuit 320 as described in FIG. 3, including the amplifier stage 322, the idle timer 324, and the power switch 326. Moreover, the IC 526 includes a socket for receiving the MPE sensor 528. When the IC 526 is integrated with the MPE sensor 528, they can be contained within a single IC package.

The IC 526 also includes bonding pads that are connected with the power ports (e.g., 302, 304, and 306) of the switch logic circuit 320. These bonding pads are coupled with the external electrodes respectively. By means of bonding, for example, the first power electrode 522 is coupled with the first power port 302; the second power electrode 524 is coupled with the second power port 304; and the auxiliary power electrode 529 is coupled with the auxiliary power port 306.

According to an aspect of the present disclosure, the insertable power switch 520 is sized and fitted for insertion within the switch receptacle 510. More specifically, the insertable power switch 520 is sized for fitting into a space defined by the switch receptacle chamber 511. The insertable power switch 520 can be removed from the switch receptacle 510, and it can be re-adapted to other switch receptacles.

The insertable power switch 520 is configured to complete a primary electric circuit (e.g., 202) for delivering the electric current (e.g., 242) to the electric load (e.g., 220). Specifically, the first power electrode 522 is configured to provide electrical coupling between the first terminal 512 of the switch receptacle 510 and the first power port (e.g., 302) of the IC 526, whereas the second power electrode 524 is configured to provide electrical coupling between the second terminal 514 of the switch receptacle 510 and the second power port (e.g., 304) of the IC 526. During its ON state, the insertable power switch 520 is configured to provide electrical coupling between the first and second terminals 512 and 514 of the switch receptacle 510. As a result, the first and second interception nodes 516 and 518 are electrically coupled to complete the primary electric circuit.

The insertable power switch 520 is also configured to complete an auxiliary electric circuit independent of the primary electric circuit, such that the auxiliary electric circuit remains established even when the insertable power switch 520 breaks up the primary electric circuit. Specifically, the auxiliary power electrode 529 of the insertable power switch 520 is electrical coupled to either the positive or negative terminals (e.g., 134 or 136) of a power source (e.g., 140) via the auxiliary terminal 517 and the auxiliary node 519.

The MPE sensor 528 is oriented to receive and detect the physical stress 530 asserted to the switch receptacle 510. The physical stress 530 correlates to the motion of the mechanical load. When the physical stress 530 is above the predetermined threshold, it is highly likely that the mechanical load is in motion, thereby indicating that the electronic device, to which the insertable power switch 520 is applied, is in active use or operation. On the other hand, when the physical stress 530 is below the predetermined threshold for an extended time period, it is highly likely that the mechanical load is in rest, thereby indicating that the electronic device, to which the insertable power switch 520 is applied, is not in active use or operation.

Accordingly, when the MPE sensor 528 continuously detects the physical stress 530 above the predetermined threshold, the power gate (e.g., 326) of the insertable power switch 530 allows the electric current (e.g., 142) to flow from the power source (e.g., 140) to the electrical load (e.g., 120). And when the MPE sensor 528 detects the physical stress 530 correlates to a motion below the predetermined threshold for a predetermined time period, the power gate (e.g., 326) of the insertable power switch 520 breaks up the electrical coupling between the power source (e.g., 140) and the electrical load (e.g., 120). As a result, the insertable power switch 520 intercepts and stops the delivery of the electric current (e.g., 142) when the electric device is idle for a prolong time period.

A few embodiments have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the methods and/or operations described (such as a program encoded in a computer-readable medium, which can be a memory device, a storage device, a machine-readable storage substrate, or other physical, machine-readable medium, or a combination of one or more of them).

The term “apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results unless such order is recited in one or more claims. In certain circumstances, multitasking and parallel processing may be advantageous. Moreover, the separation of various system components in the embodiments described above should not be understood as requiring such separation in all embodiments.

What is claimed is:

1. A power management system, comprising:
a power receptacle having a positive terminal and a negative terminal, the positive and negative terminals configured to receive a power source for supplying an electric current;
a load coupled with the positive and negative terminals of the power receptacle, the load configured to receive the electric current upon establishing a circuit with the power source; and
a switch structured for being deposed between the power source and the load, the switch having:
a motion sensor configured to sense a motion of the load and generate an idle signal when the sensed motion is below a predetermined threshold;
a timer coupled with the motion sensor, and configured to generate a power-off signal upon detecting the idle signal for a predetermined time period; and
a gate coupled with the timer, and configured to break up the circuit by isolating the load from the power source upon receiving the power-off signal.

2. The system of claim 1, wherein the motion sensor includes a micro-electromechanical system based (MEMS-based) piezoelectric sensor configured to sense a physical stress correlating to the motion of the load.

3. The system of claim 1, wherein:
the power receptacle includes a chamber structured to house the power source between the positive and negative terminals;
the motion sensor is configured to sense a physical stress between the chamber and the power source.

4. The system of claim 1, wherein:
the switch is insertable between the positive terminal of the receptacle and the power source; and
the gate of the switch is configured to break up the circuit by insulating the positive terminal from the power source upon receiving the power-off signal.

5. The system of claim 1, wherein:
the switch is insertable between the negative terminal of the receptacle and the power source; and
the gate of the switch is configured to break up the circuit by insulating the negative terminal from the power source upon receiving the power-off signal.

6. The system of claim 1, wherein:
the switch is positioned between the positive terminal of the receptacle and the load; and
the gate of the switch is configured to break up the circuit by disconnecting the load from the positive terminal upon receiving the power-off signal.

7. The system of claim 1, wherein:
the switch is positioned between the negative terminal of the receptacle and the load; and
the gate of the switch is configured to break up the circuit by disconnecting the load from the negative terminal upon receiving the power-off signal.

8. The system of claim 1, wherein the gate of the switch is insertable along the circuit to intercept the electric current upon receiving the power-off signal.

9. A power management system, comprising:
a power receptacle configured to receive a power source;
a load coupled with the power receptacle, the load configured to receive an electric current upon establishing a circuit with the power source;
a user interface coupled with the load, and configured to receive a user input for operating the load while the load conducts the electric current; and
a switch structured for being deposed between the power source and the load, the switch having:
a motion sensor configured to sense a motion induced by the user input and generate an idle signal when the sensed motion is below a predetermined threshold;
a timer coupled with the motion sensor, and configured to generate a power-off signal upon detecting the idle signal for a predetermined time period; and
a gate coupled with the timer, and configured to break up the circuit by isolating the load from the power source upon receiving the power-off signal.

10. The system of claim 9, wherein the motion sensor includes a micro-electromechanical system based (MEMS-based) piezoelectric sensor configured to sense a physical stress correlating to the motion induced by the user input.

11. The system of claim 9, wherein:
the motion sensor is attachable to the user interface for sensing the motion induced by the user input; and
the gate is insertable along the circuit to intercept the electric current upon receiving the power-off signal.

12. The system of claim 9, wherein:
the power receptacle includes a positive terminal and a negative terminal for coupling with the power source;
the switch is positioned between the positive terminal of the receptacle and the load; and
the gate of the switch is configured to break up the circuit by disconnecting the load from the positive terminal upon receiving the power-off signal.

13. The system of claim 9, wherein:
the power receptacle includes a positive terminal and a negative terminal for coupling with the power source;
the switch is positioned between the negative terminal of the receptacle and the load; and
the gate of the switch is configured to break up the circuit by disconnecting the load from the negative terminal upon receiving the power-off signal.

14. A micro-electromechanical system based (MEMS-based) switch for use in a power management system including a power source for supplying an electrical current and a load configured to receive the electric current upon establishing a circuit with the power source, the MEMS-based switch comprising:
a MEMS-based motion sensor configured to sense a motion related to an operation of the load and generate an idle signal when the sensed motion is below a predetermined threshold;
a timer coupled with the MEMS-based motion sensor, and configured to activate a power-off signal upon detecting the idle signal for a predetermined time period; and
a gate structured for being deposed between the load and the power source, the gate coupled with the timer, and the gate configured to either complete the circuit when the power-off signal is inactive or break up the circuit when the power-off signal is active.

15. The switch of claim 14, wherein the MEMS-based motion sensor includes a MEMS-based piezoelectric sensor.

16. The switch of claim 14, wherein the MEMS-based motion sensor is configured to sense a physical stress correlating to the motion of the load.

17. The switch of claim 14, wherein the MEMS-based motion sensor is configured to sense a physical stress correlating to the motion induced by a user input for operating the load.

18. The switch of claim 14, wherein the gate is structured to either:
pass the electric current from the power source to the load when the power-off signal is inactive; or
intercept the electric current from the power source to the load when the power-off signal is activate.

19. The switch of claim 14, further comprising:
a package housing the MEMS base motion sensor, the timer, and the gate, the package is structured to fit between the power source and the load.
The switch of claim 19, wherein the package is removably insertable between the power source and a power receptacle chamber for housing the power source.
